(19) United States
(12) Patent Application Publication
(10) Pub. No.: US 2012/0268610 A1
(43) Pub. Date: Oct. 25, 2012

(54) INFORMATION TERMINAL CAPABLE OF TRANSMITTING FILE

(75) Inventors: Kazuo INUI, Itami-shi (JP); Hidetaka Iwai, Itami-shi (JP); Toshikazu Kawaguchi, Kobe-shi (JP); Toshihiko Otake, Ikeda-shi (JP); Masayuki Kawamoto, Amagasaki-shi (JP)

(73) Assignee: Konica Minolta Business Technologies, Inc., Chiyoda-ku (JP)

(21) Appl. No.: 13/442,997

(22) Filed: Apr. 10, 2012

(30) Foreign Application Priority Data
Apr. 19, 2011 (JP) 2011-092740

(51) Int. Cl. H04N 5/225; G06F 3/041; G06F 15/16

(52) U.S. Cl. 348/207.1; 709/217; 345/173; 348/E05.024

(57) ABSTRACT

An information terminal capable of transmitting a file to another device includes a display unit; a storage unit for storing a relationship between an image and a transmission destination; a designation unit for designating the image as a standby image of the display unit; an operation unit for receiving an operation to instruct transmission of the file; and a processing unit for performing a process of transmitting the file to another device in accordance with the operation. The processing unit performs a process of specifying, as a transmission destination of the file, the transmission destination related to the image set as the standby image in the display unit at a time when the operation unit receives the operation, for transmitting the file.

This application is based on Japanese Patent Application No. 2011-092740 filed with the Japan Patent Office on Apr. 19, 2011, the entire content of which is hereby incorporated by reference.

### BACKGROUND OF THE INVENTION

1. Field of the Invention

The present invention relates to an information terminal, and particularly to an information terminal having a communication function.

2. Description of the Related Art

Information terminals such as a mobile phone and a personal computer may be used to transmit files to other devices.

For example, when an e-mail message having a file attached thereto is transmitted, the information terminal is generally operated to first start a program for e-mail referred to as a mailer, select an address from an address book and specify the file to be transmitted, to perform the transmission operation.

However, there is a problem that a complicated operation should be performed for transmitting files, as described above. Particularly, there is a problem that it is complicated to perform operations, each time the need arises, to select and input a transmission destination to which files are transmitted with a high frequency.

### SUMMARY OF THE INVENTION

The present invention has been made in light of the above-described problems, and an object of the present invention is to provide an information terminal capable of transmitting a file to a transmission destination in a simple operation.

In order to achieve the above-described object, according to an aspect of the present invention, an information terminal capable of transmitting a file to another device includes a display unit; a storage unit for storing a relationship between an image and a transmission destination; a designation unit for designating the image as a standby image of the display unit; an operation unit for receiving an operation to instruct transmission of the file; and a processing unit for performing a process of transmitting the file to another device in accordance with the operation. The processing unit performs a process of specifying, as a transmission destination of the file, the transmission destination related to the image set as the standby image in the display unit at a time when the operation unit receives the operation, for transmitting the file.

Preferably, the information terminal further includes a setting unit for setting the relationship between the image and the transmission destination.

Preferably, the information terminal further includes a creation unit for creating the file. The processing unit performs a process of specifying, as the transmission destination of the file, the transmission destination related to the image set as the standby image in the display unit at a time of completion of creation of the file in the creation unit, and, upon completion of creation of the file, transmitting the file to the transmission destination.

More preferably, the information terminal further includes a camera. The creation unit creates the file based on an image taken by the camera.

According to another aspect of the present invention, an information terminal capable of transmitting a file to another device including a touch panel; a storage unit for storing a relationship between an operation pattern on the touch panel and a transmission destination; and a processing unit for performing a process of transmitting the file to another device in accordance with an operation on the touch panel. The processing unit performs a process of specifying the operation pattern on the touch panel and specifying the transmission destination related to the operation pattern as a transmission destination of the file, for transmitting the file.

Preferably, the operation on the touch panel is an operation in which the touch panel is touched at one or more points, at least one of which is continuously shifted in position while maintaining a touched state, and then, the touched state is ended. The operation pattern stored in the storage unit is a track of the position that is shifted while maintaining the touched state at the one point.

Preferably, the operation on the touch panel is an operation of simultaneously touching a plurality of points on the touch panel at least at one point of time. The operation pattern stored in the storage unit shows a positional relationship among a plurality of points.

Preferably, the processing unit performs a process of specifying a file represented by an icon that is displayed on the touch panel and is to be subjected to the operation on the touch panel as a file that is to be subjected to the process of transmission, for performing said transmission.

Preferably, the information terminal is portable by a human.

According to still another aspect of the present invention, a non-transitory computer-readable storage medium stores a control program for causing an information terminal to perform a process of transmitting a file. The information terminal includes a display unit, a storage unit and a controller. The storage unit stores a relationship between an image and a transmission destination. The program causes the information terminal to perform the steps of: receiving an instruction to transmit the file; specifying, as a transmission destination of the file, the transmission destination related to the image set as a standby image in the display unit at a time when receiving the instruction; and transmitting the file to the transmission destination.

According to still another aspect of the present invention, a non-transitory computer-readable storage medium stores a control program for causing an information terminal to perform a process of transmitting a file. The information terminal includes a touch panel, a controller and a storage unit. The storage unit stores a relationship between an operation pattern on the touch panel and a transmission destination. The program causes the information terminal to perform the steps of: receiving an instruction to the touch panel to transmit the file; specifying the operation pattern on the touch panel and specifying the transmission destination related to the operation pattern as a transmission destination of the file; and transmitting the file to the transmission destination.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a specific example of the configuration of an information terminal according to an embodiment.

FIG. 2 is a block diagram showing a specific example of the function configuration of the information terminal according to the first embodiment.

FIG. 3 is a diagram showing a specific example of the correspondence relationship between a standby image and an address that are stored in a standby table.

FIG. 4 is a flowchart showing the operation of transmitting a file in the information terminal according to the first embodiment.

FIG. 5 is a diagram showing a specific example of a confirmation screen.

FIGS. 6A to 6C each are a diagram showing a specific example of a gesture operation received by the information terminal according to the second embodiment.

FIG. 7 is a block diagram showing a specific example of the function configuration of the information terminal according to the second embodiment.

FIG. 8 is a diagram showing a specific example of the correspondence relationship between the gesture operation and the address that are stored in a gesture table.

FIG. 9 is a flowchart showing the operation of transmitting a file in the information terminal according to the second embodiment,

FIGS. 10A to 10C each are a diagram showing an example of the gesture pattern according to a modification.

FIG. 11 is a flowchart showing the operation of transmitting a file in the information terminal according to the modification of the second embodiment,

### DESCRIPTION OF THE PREFERRED EMBODIMENTS

The embodiments of the present invention will be hereinafter described with reference to the accompanying drawings. In the following description, the same parts and components are designated by the same reference characters. Names and functions thereof are also the same.

<Device Configuration>

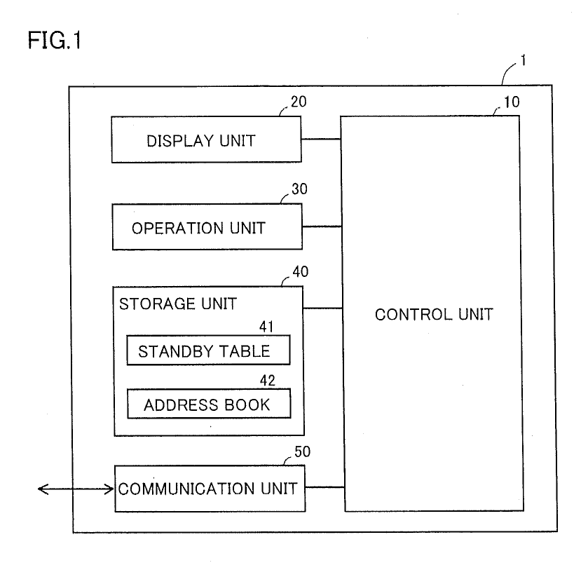

FIG. 1 is a diagram showing a specific example of the configuration of an information terminal 1 according to the present embodiment. Information terminal 1 only needs to have at least a transmission function and have a portable size and weight for a human by carrying (wearing) the terminal on a part of the body such as a hand or a part of clothes. For example, devices such as a mobile phone and a portable personal computer apply thereto.

Referring to FIG. 1, information terminal 1 includes a control unit 10 including a CPU (Central Processing Unit) (not shown) for controlling the entire device, a display unit 20, an operation unit 30, a storage unit 40, and a communication unit 50 for communicating with other devices.

Storage unit 40 stores a program executed by the CPU in control unit 10 and also includes a standby table 41 for storing the information about the image displayed on a standby screen (which will be hereinafter referred to as a standby image) and an address book 42.

### First Embodiment <Summary of Operation>

In information terminal 1 according to the first embodiment, an address of the transmission destination is related for each of standby images. Then, when the user gives an instruction for transmission in the state where the standby image is displayed that is related to the address to which the standby image is desired to be transmitted, the relevant file is transmitted to the address related to the standby image,

<Function Configuration>

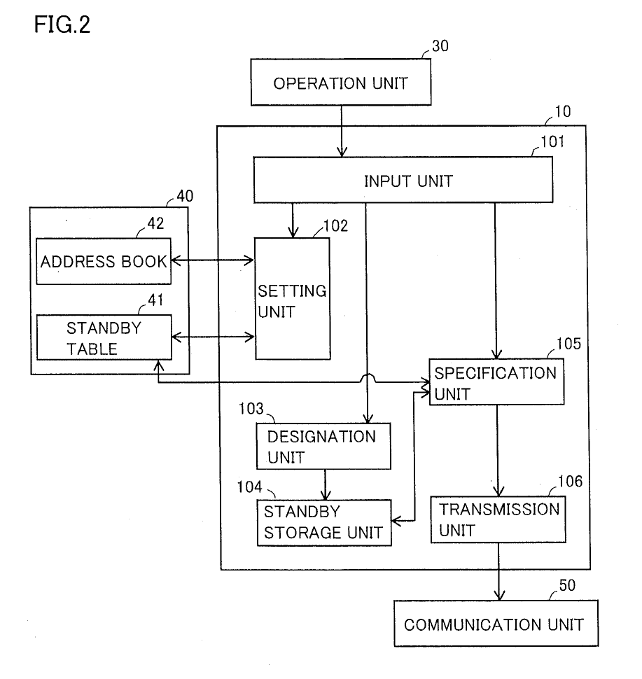

FIG. 2 is a block diagram showing a specific example of the function configuration of information terminal 1 according to the first embodiment. Each function shown in FIG. 2 is implemented mainly in the CPU (not shown) included in control unit 10 by this CPU reading and executing the program stored in storage unit 40. However, at least a part of the functions may be implemented by the hardware configuration shown in FIG. 1.

Referring to FIG. 2, information terminal 1 according to the first embodiment includes an input unit 101 for receiving, from operation unit 30, an input of the operation signal associated with the operation of operation unit 30; a setting unit 102 for, in the case where the operation signal is to give an instruction to relate the standby image to the address, causing standby table 41 to store the relationship between the intended address read from address book 42 and the designated standby image in response to this instruction, thereby setting this relationship; a designation unit 103 for, in the case where the operation signal is to designate a standby image to be displayed on the standby screen, designating the standby image in accordance with the designation; a standby storage unit 104 for storing the standby image set as a standby image to be displayed on the standby screen; a specification unit 105 for, in the case where the operation signal is to give an instruction to transmit a file, specifying the file to be transmitted while referring to standby storage unit 104, to specify the standby image that is currently set to specify the address related to the standby image as a transmission destination; and a transmission unit 106 for transmitting the designated file to the specified address.

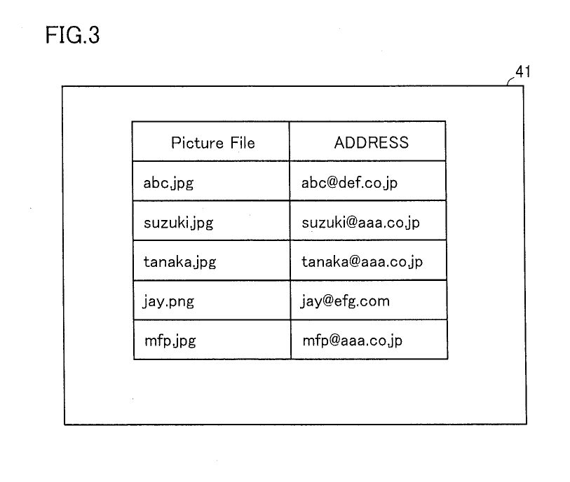

FIG. 3 is a diagram showing a specific example of the correspondence relationship between a standby image and an address that are stored in standby table 41. Referring to FIG. 3, standby table 41 stores addresses that are related for each of standby images. In addition, although FIG. 3 shows an example in which one address is related to one standby image, a plurality of addresses may be related to one standby image. Furthermore, the same address may be related to a plurality of standby images.

<Operation Flow>

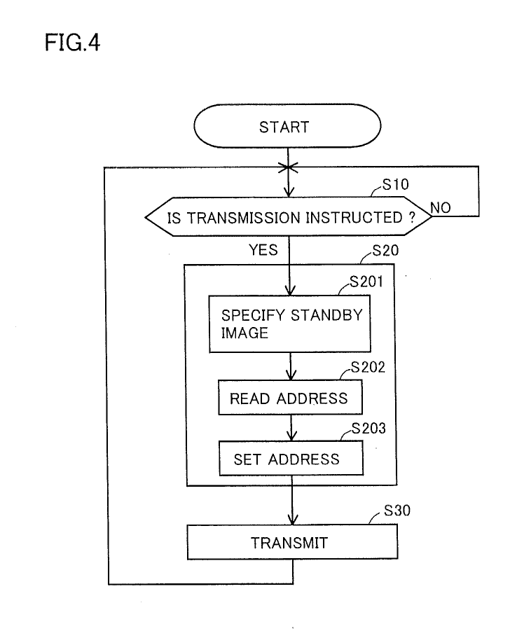

FIG. 4 is a flowchart showing the operation of transmitting a file in information terminal 1 according to the first embodiment. The operation shown in the flowchart in FIG. 4 is implemented by the CPU (not shown) in information terminal 1 reading and executing the program stored in storage unit 40 to cause each unit shown in FIG. 3 to function.

Referring to FIG. 4, when receiving an input of the operation signal instructing transmission of the file from operation unit 30 (YES in step S10), the CPU executes the process for specifying the transmission destination in step S20.

Specifically, in step S201, the CPU specifies the standby image that is set to be displayed on the standby screen at the point of time when an instruction is given to transmit a file. In step S202, the CPU refers to standby table 41 to read the address related to the relevant standby image. Then, in step 5203, the CPU specifies the read address as an address of the transmission destination.

In step S30, the CPU performs the process for transmission. In other words, the CPU starts the program for e-mail transmission, to write the address specified in step S20 as a transmission destination and attach the designated file as an attached file. Then, the e-mail is transmitted.

### Effect of Embodiment

As the above-described process is performed in information terminal 1 according to the first embodiment, the user designates the file to be transmitted and gives an instruction to transmit the file in the state where the image related to the address to which the file is desired to be transmitted is displayed as a standby image on the standby screen, which allows the user to transmit the file to the intended transmission destination in a simple operation without having to perform the operation to read/input the address from/into the address book.

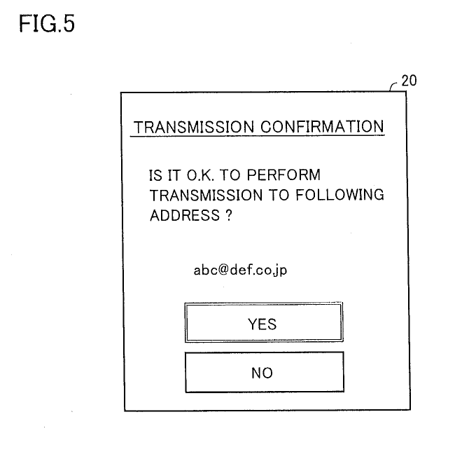

In addition, the above-described example shows that the file is automatically transmitted only by the instruction for transmission. However, at the point of time when the address is specified in step S20 described above, such a message as presenting the transmission destination specified from the standby image and confirming whether or not to perform transmission may be displayed, for example, as shown in FIG. 5. In the case where a plurality of addresses are related to one standby image, the confirmation screen may display the plurality of addresses at one time to confirm whether or not to perform transmission, or may sequentially display confirmation screens for confirming whether or not to perform transmission for each of the addresses. In this way, the file can be prevented from being transmitted to an unintended transmission destination.

Alternatively, in contrast, the process up to transmission of the specified file may be completed by receiving an instruction for transmission at the time when the standby image is being displayed. This allows completion of transmission of the file without having to display the confirmation screen, and therefore, without having to display the transmission destination on the screen. Accordingly, even in the case where another person peeks at the screen, the transmission destination cannot be exposed to this another person, so that the security for the transmission destination can be ensured.

<Modification>

In information terminal 1 according to the first embodiment, the above-described instruction to transmit a file may be made based on completion of creation of the file in place of the operation on operation unit 30. In other words, when the CPU monitors execution of the application for file creation to detect completion of creation of the file by the application, the CPU may regard this detection as an instruction to transmit the file.

For example, in the case where the file including a photographic image is intended to be transmitted, a camera (not shown) mounted in information terminal 1 is used to take a photograph to acquire a photographic image in accordance with the process by the photography application. Then, the CPU detects this acquisition of the photographic image, and then, transmits the file including this photographic image to the address related to the image set as a standby image upon completion of acquisition of the photographic image.

Due to the operation performed as described above, when the user creates a file by taking a photograph by a camera in the state where the image related to the destination to which the file is desired to be transmitted is displayed as a standby image, and by saving the document file created by the document creation application or ending the document creation application, this file is to be automatically transmitted to the above-described destination to which the relevant file is desired to be transmitted.

### Second Embodiment

<Summary of Operation>

Information terminal 1 according to the second embodiment has a touch panel formed of display unit 20 and operation unit 30.

Information terminal 1 according to the second embodiment specifies the file to be transmitted and the transmission destination based on the gesture operation from the touch panel, and transmits the file to the transmission destination.

In this case, the gesture operation means a series of operations in which the touch panel is touched at one or more points, at least one of which is continuously shifted in position, and then, the touch is released from the touch panel.

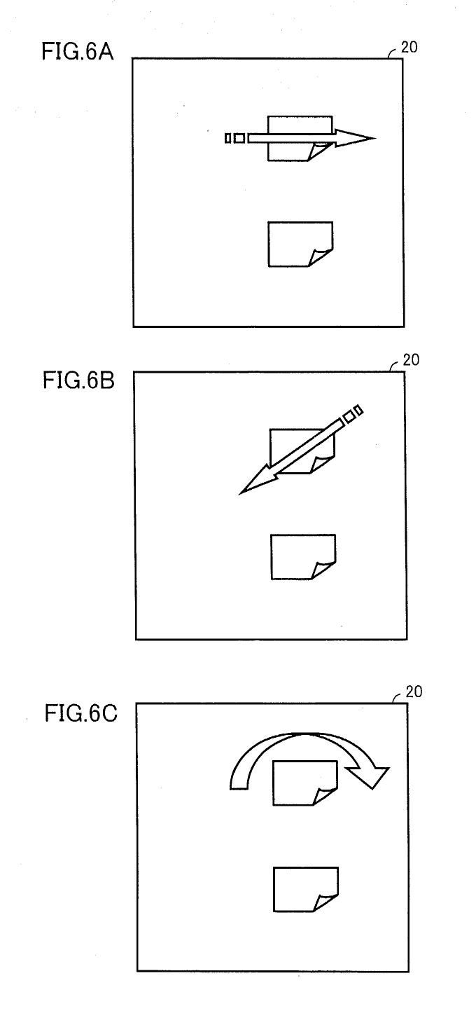

FIGS. 6A to 6C each are a diagram showing a specific example of a gesture operation received by information terminal 1 according to the second embodiment.

As an example of the first gesture operation, FIG. 6A shows an operation in which the touch panel is touched at one point on the left side of the icon representing a file, the touched position is continuously shifted from that position linearly toward the right side on the icon, and then, the touch is released from the touch panel.

As an example of the second gesture operation, FIG. 6B shows an operation in which the touch panel is touched at one point on the upper right of the icon representing a file, the touched position is continuously shifted from that position linearly toward the lower left of the icon, and then, the touch is released from the touch panel.

As an example of the third gesture operation, FIG. 6C shows an operation in which the touch panel is touched at one point on the left side of the icon representing a file, the touched position is continuously shifted in the shape of an arc from that position through the upper side to the right side of the icon, and then, the touch is released from the touch panel.

As the above-described gesture operation is received, the file represented by the icon that is to be subjected to the gesture operation is specified as a file to be transmitted, and the address related to the operation pattern represented by this gesture operation is specified as a transmission destination,

In addition, the operation pattern used herein (which is also referred to as a gesture pattern) means a track following the continuously shifting position of at least one of points at which the touch panel is touched.

<Function Configuration>

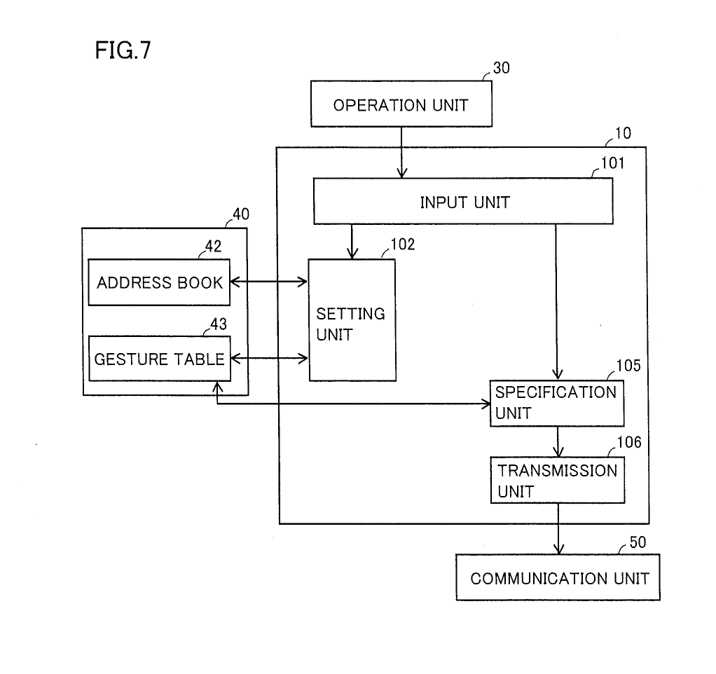

FIG. 7 is a block diagram showing a specific example of a function configuration of information terminal 1 according to the second embodiment. Each function shown in FIG. 7 is also implemented mainly in the CPU (not shown) included in control unit 10 by this CPU reading and executing the program stored in storage unit 40. However, at least a part of the functions may be implemented by the hardware configuration shown in FIG. 1.

Referring to FIG. 7, information terminal 1 according to the second embodiment does not include designation unit 103 and standby storage unit 104 shown in FIG. 2, but has a function almost similar to that of information terminal 1 according to the first embodiment. In information terminal 1 according to the second embodiment, storage unit 40 includes address book 42 and a gesture table 43 storing the correspondence relationship between the gesture operation and the address.

In information terminal 1 according to the second embodiment, in the case where the operation signal received by input unit 101 is to give an instruction to relate the gesture operation to the address, setting unit 102 responds to the instruction to store, in gesture table 43, the relationship between the intended address that was read from address book 42 and the gesture operation that was input.

In the case where the operation signal is to give an instruction to transmit the file, specification unit 105 specifies the gesture operation based on the operation signal, specifies the icon to be subjected to the operation to thereby specify the file to be transmitted, and refers to gesture table 43 to specify the address related to the specified gesture operation as a transmission destination.

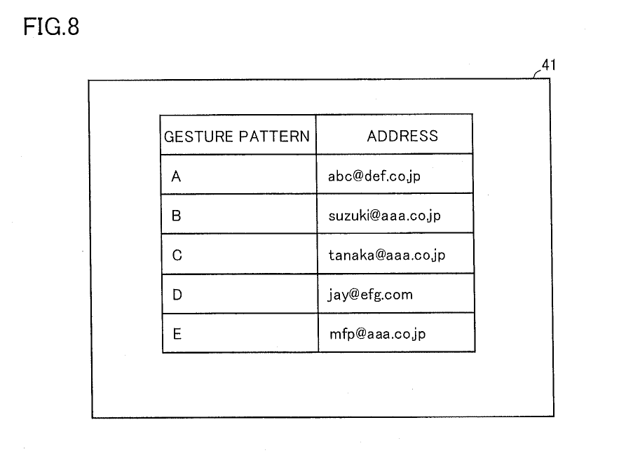

FIG. 8 is a diagram showing a specific example of the correspondence relationship between the gesture operation and the address that are stored in gesture table 43. Referring to FIG. 8, gesture table 43 stores the address that is related for each of the patterns of the operation represented by the gesture operation (gesture pattern). In addition, although FIG. 8 shows an example in which one address is related to one gesture pattern, a plurality of addresses may be related to one gesture pattern. Furthermore, the same address may be related to a plurality of gesture patterns.

<Operation Flow>

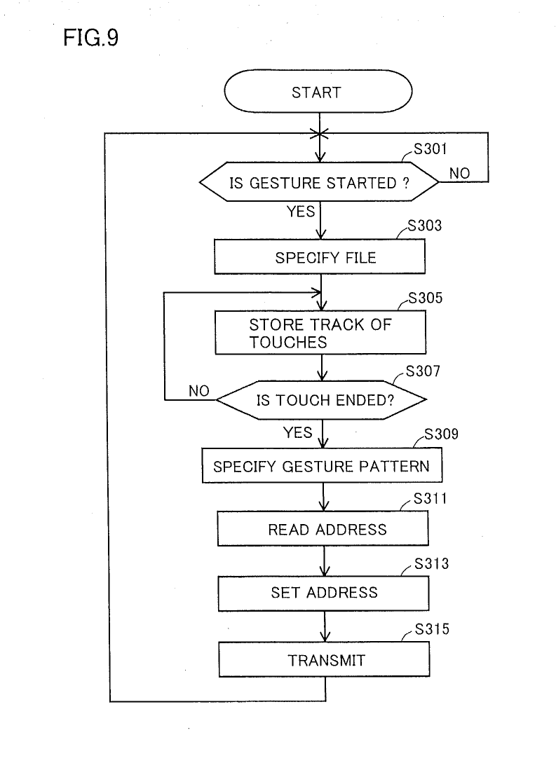

FIG. 9 is a flowchart showing the operation of transmitting a file in information terminal 1 according to the second embodiment. The operation shown in the flowchart in FIG. 9 is implemented by the CPU (not shown) in information terminal 1 reading and executing the program stored in storage unit 40 to cause each unit shown in FIG. 7 to function.

Referring to FIG. 9, when the CPU detects based on the operation signal from operation unit 30 that the gesture operation is started (YES in step S301), in step S303, the CPU specifies the icon that is to be subjected to the gesture operation, thereby specifying the file represented by this icon as a file to be transmitted.

In step S305, the CPU continuously stores the track drawn on the touch panel by the gesture operation started in step S 301 until the touch is released from the touch panel (NO in step S307). Then, when the touch is released from the touch panel and the gesture operation is ended (YES in step S307), the CPU specifies the gesture pattern by the track of a series of the touches on the touch panel in step S309, and refers to gesture table 43 to read the address related to the relevant gesture pattern in step S311.

In step S313, the CPU starts the program for e-mail transmission and writes the address that is read in step S311 as a transmission destination. Then, in step S315, the CPU attaches the file specified as an object to be transmitted in the above-described step S303 as an attached file, and then transmits the e-mail.

### Effect of Embodiment

As the above-described process is performed in information terminal 1 according to the second embodiment, the user can transmit the file to the intended transmission destination in a simple operation by performing the gesture operation related to the transmission destination for the icon representing the file that is desired to be transmitted, without having to perform an operation to read/input the address from/into the address book.

As in the first embodiment, information terminal 1 according to the second embodiment may also be configured such that, during transmission, the address specified by the gesture operation is displayed to confirm whether or not to perform transmission. In contrast, the process up to transmission of the specified file may be completed by receiving the gesture operation without having to display a confirmation screen,

<Modification>

In information terminal 1 according to the above-described second embodiment, the address is specified by the gesture pattern represented as a gesture operation by continuous shift of one or more points. Relating to an address is not limited to the gesture operation of such a gesture pattern, but the gesture operations of other gesture patterns may also be applied. Examples of other gesture patterns may include a gesture pattern in which the touch panel is simultaneously touched at a plurality of points.

It is to be noted that the term “simultaneously” is not limited to the meaning that the timings at which all of the points are first touched are the same, but only needs to mean that a plurality of points are touched at least at any one point of time. In other words, the state where the touch panel is touched simultaneously at a plurality of points also includes the state where the touch panel is touched one at a time and eventually being touched at a plurality of points.

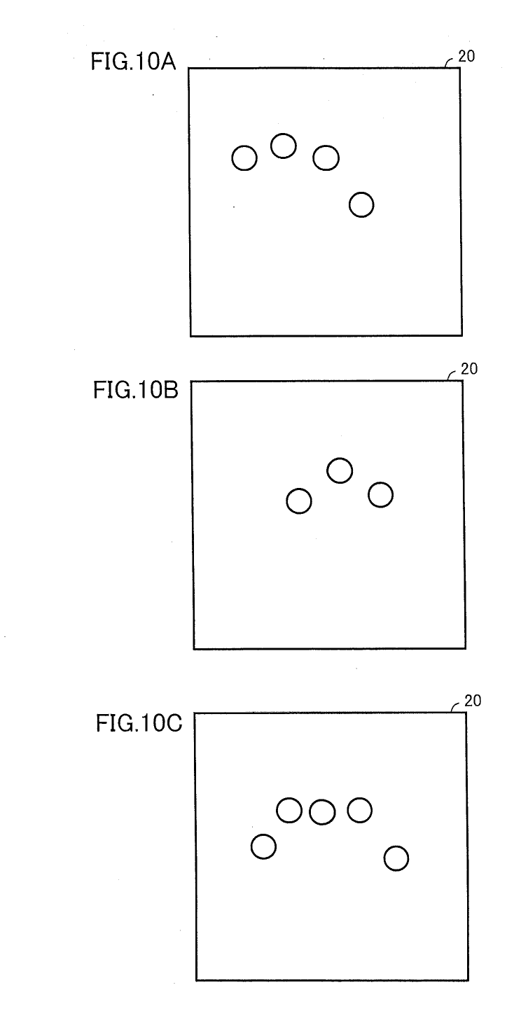

In this case, gesture table 43 stores the positional relationship about a plurality of touched points on the touch panel and also stores the correspondence relationship between the positional relationship and the address. FIGS. 10A to 10C each are a diagram showing an example of the gesture pattern according to the modification. In other words, as an example of the first gesture pattern according to the modification, FIG. 10A shows the positional relationship among four points that are simultaneously touched. As an example of the second gesture pattern according to the modification, FIG. 10B also shows the positional relationship among three points that are simultaneously touched. As an example of the third gesture pattern according to the modification, FIG. 10C also shows the positional relationship among five points that are simultaneously touched. The above-described gesture patterns may be stored as a relative position such as representing other points by coordinate values using any of the points as a starting point.

When the gesture operation is performed in which a plurality of points are simultaneously touched, specification unit 105 specifies their respective touched positions based on the operation signal, and compares the relative positional relationship with the stored gesture pattern, to thereby specify the gesture pattern and specify the related address.

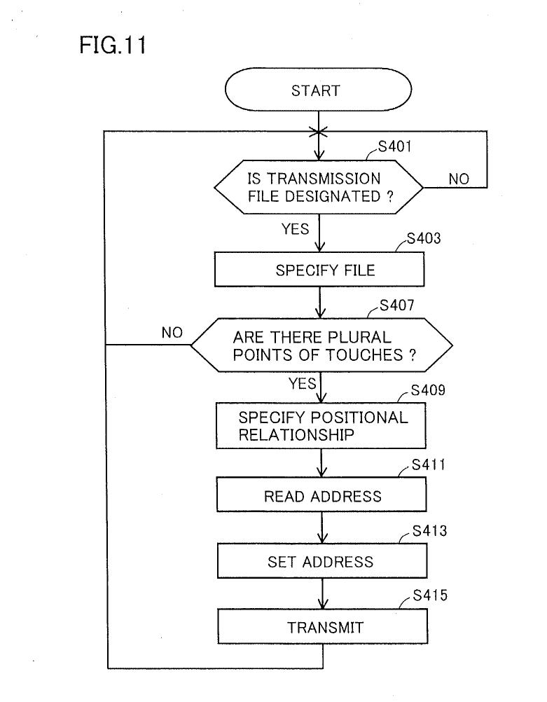

FIG. 11 is a flowchart showing the operation of transmitting a file in information terminal 1 according to the modification of the second embodiment. The operation shown in the flowchart in FIG. 11 is also implemented by the CPU (not shown) in information terminal 1 reading and executing the program stored in storage unit 40 to cause each unit shown in FIG. 7 to function.

Referring to FIG. 11, when receiving designation of the file to be transmitted by the operation that is defined in advance (YES in step S401), the CPU specifies this file as a file to be transmitted in step S403.

Then, when the touch panel is simultaneously touched at a plurality of points (YES in step S407), in step S409, the CPU relatively specifies the positional relationship among the plurality of points and compares this relationship with the gesture pattern stored in gesture table 43, thereby specifying the gesture pattern. Then, in step S411, the CPU refers to gesture table 43 to read the address related to the specified gesture pattern.

The subsequent process is performed in the manner similar to that in the above-described operation. That is, in step S413, the CPU starts the program for e-mail transmission and writes the address read in step S411 as a transmission destination. Then, in step S415, the CPU attaches the file specified as an object to be transmitted in the above-described step S403 and transmits the e-mail.

Also in the above-described configuration, similarly, the gesture operation related to the transmission destination is performed, thereby allowing transmission of the file to the intended transmission destination in a simple operation without having to perform an operation to read/input the address from/into the address book.

Furthermore, it is also possible to provide a program for causing the CPU in information terminal 1 to perform the above-described operation. The above-described program can be recorded on a non-transitory computer-readable recording medium such as a flexible disk attached to the computer, a CD-ROM (Compact Disk-Read Only Memory), a ROM (Read Only Memory), a RAM (Random Access Memory), and a memory card, and thus, provided as a program product. Alternatively, the program recorded on a non-transitory recording medium such as a hard disk incorporated in a computer can be provided. Furthermore, the program can also be provided by download via a network.

In addition, the program according to the present invention may cause the process to be executed by invoking a required module in a prescribed arrangement at a prescribed timing from program modules provided as part of the operating system (OS) of the computer. In this case, the program itself does not include the above-described modules but cooperates with the OS to execute the process. The program not including the above-described modules may also be included in the program according to the present invention.

Furthermore, the program according to the present invention may be incorporated in a part of another program. Also in such a case, the program itself does not include any modules included in the above-described another program, but cooperates with another program to execute the process. The program included in another program as described above may also be included in the program according to the present invention.

The program product to be provided is installed in a program storage unit such as a hard disk for execution. It is to be noted that a program product includes a program itself and a non-transitory recording medium recording the program.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An information terminal capable of transmitting a file to another device, said information terminal comprising:
a display unit;
a storage unit for storing a relationship between an image and a transmission destination;
a designation unit for designating said image as a standby image of said display unit;
an operation unit for receiving an operation to instruct transmission of said file; and
a processing unit for performing a process of transmitting said file to said another device in accordance with said operation,
said processing unit performing a process of specifying, as a transmission destination of said file, the transmission destination related to the image set as the standby image in said display unit at a time when said operation unit receives said operation, for transmitting said file.

2. The information terminal according to claim 1, further comprising a setting unit for setting the relationship between said image and said transmission destination.

3. The information terminal according to claim 1, further comprising a creation unit for creating said file, wherein
said processing unit performs a process of specifying, as the transmission destination of said file, the transmission destination related to the image set as the standby image in said display unit at a time of completion of creation of said file in said creation unit, and, upon completion of creation of said file, transmitting said file to said transmission destination.

4. The information terminal according to claim 3, further comprising a camera, wherein
said creation unit creates said file based on an image taken by said camera.

5. The information terminal according to claim 1, wherein said information terminal is portable by a human.

6. An information terminal capable of transmitting a file to another device, said information terminal comprising:
a touch panel;
a storage unit for storing a relationship between an operation pattern on said touch panel and a transmission destination; and
a processing unit for performing a process of transmitting said file to said another device in accordance with an operation on said touch panel,
said processing unit performing a process of specifying the operation pattern on said touch panel and specifying the transmission destination related to said operation pattern as a transmission destination of said file, for transmitting said file.

7. The information terminal according to claim 6, wherein
the operation on said touch panel is an operation in which said touch panel is touched at one or more points, at least one of which is continuously shifted in position while maintaining a touched state, and then, the touched state is ended, and
said operation pattern stored in said storage unit is a track of the position that is shifted while maintaining said touched state at said one point.

8. The information terminal according to claim 6, wherein
the operation on said touch panel is an operation of simultaneously touching a plurality of points on said touch panel at least at one point of time, and
said operation pattern stored in said storage unit shows a positional relationship among a plurality of points,

9. The information terminal according to claim 6, wherein said processing unit performs a process of specifying a file represented by an icon that is displayed on said touch panel and is to be subjected to the operation on said touch panel as a file that is to be subjected to said process of transmission, for performing said transmission.

10. The information terminal according to claim 6, wherein said information terminal is portable by a human.

11. A non-transitory computer-readable storage medium storing a control program for causing an information terminal to perform a process of transmitting a file,
said information terminal including a display unit, a storage unit for storing a relationship between an image and a transmission destination, and a controller,
said program causing said information terminal to perform the steps of:
receiving an instruction to transmit said file;
specifying, as a transmission destination of said file, the transmission destination related to the image set as a standby image in said display unit at a time when receiving said instruction; and
transmitting said file to said transmission destination.

12. A non-transitory computer-readable storage medium storing a control program for causing an information terminal to perform a process of transmitting a file,
said information terminal including a touch panel, a controller and a storage unit for storing a relationship between an operation pattern on said touch panel and a transmission destination,
said program causing said information terminal to perform the steps of:
receiving an instruction to said touch panel to transmit said file;
specifying the operation pattern on said touch panel and specifying the transmission destination related to said operation pattern as a transmission destination of said file; and
transmitting said file to said transmission destination.
